(19) United States
(12) Patent Application Publication
(10) Pub. No.: US 2007/0236476 A1
(43) Pub. Date: Oct. 11, 2007

(54) INPUT DEVICE AND COMPUTER SYSTEM USING THE INPUT DEVICE

(75) Inventor: Shoji Suzuki, Fukushima-ken (JP)

Correspondence Address: BRINKS HOFER GILSON & LIONE, P.O. BOX 10395, CHICAGO, IL, 60610, US

(73) Assignee: ALPS ELECTRIC CO., LTD., Tokyo (JP)

(21) Appl. No.: 11/697,212

(22) Filed: Apr. 5, 2007

(30) Foreign Application Priority Data
Apr. 6, 2006 (JP) 2006-105276

(51) Int. Cl. G06F 3/041

(52) U.S. Cl. 345/173

(57) ABSTRACT

An input device enables a user to easily and precisely select menu indications displayed in a display image. A capacitance-type input pad and a computer system are provided. Menu open regions and an operation region are set on an input surface of a capacitance type input pad. When a finger touches one menu open region, a menu picture corresponding to a menu indication of a display image is displayed. Subsequently, when the finger slides in the X direction, the menu picture corresponding to the other menu indication is displayed. When the finger 50 slides in the Y direction individual menus in the menu picture are sequentially selected. Then, when an execution operation is carried out, a program corresponding to the selected individual menu is executed.

This application claims the benefit of priority under 35 U.S.C. § 119 to Japanese Patent Application No. 2006-105276 filed Apr. 6, 2006, which is hereby incorporated by reference in its entirety.

### BACKGROUND OF THE INVENTION

1. Field of the Invention

The present invention relates to a capacitance-type an input device that enables a user to easily perform an operation of selecting menus indicated in a display image or window.

2. Description of the Related Art

In an operating panel of a personal computer such as a notebook computer, a capacitance type input pad in a front side of the keyboard device is provided. In addition, in the front side of the input pad, an L key at the left and an R key at the right are provided.

In the input pad, there are provided a plurality of X electrodes and Y electrodes having an insulating sheet interposed therebetween. Electric potential is sequentially supplied to the X electrodes and Y electrodes. The surface of the input pad is covered with an insulating cover. When a user's finger, which is an electric conductor, touches the surface of the cover, capacitance between an electrode located at or near the location where the finger touches, and an electrode located adjacent to the electrode, is changed. As a result, any location on the X-Y coordinates of the input pad where the finger touches can be detected.

In general, this input pad is used in substitute for a mouse input device. A pointer displayed on a screen is moved by moving the finger, which touches the surface of the input pad. In the input pad, it is possible to recognize the location which has been operated with the finger on the X-Y coordinates. For that reason, it is possible to input a specific operation signal by designating a predetermined region of an input surface of the input pad as a specific region and tapping the specific region as described in JP-A-2005-135441.

### SUMMARY OF THE INVENTION

As for modes to be set by operating a specific region set on an input surface of the above-mentioned input pad, an auto-scroll setting, an easy launcher setting, a program actuation setting, a click operation setting, and the like were generally used in the past.

In order to display a menu content corresponding to a menu indication displayed in a menu bar of an activated display image (window) displayed on a display screen, it is necessary to move a pointer displayed on the screen to a location of the menu indication by operating the input pad by a finger. By tapping the input pad without moving a location of the pointer, a pull-down menu corresponding to the menu indication is opened. By moving the pointer by operating the input pad with the finger, and arranging the pointer in an individual menu in the pull-down menus, the individual menu is selected. In addition, in order to execute a program corresponding to the individual menu, it is necessary to tap the input surface of the input pad without moving the pointer from the selected individual menu.

As mentioned above, in order to execute the program corresponding to the individual menu by using the known input pad, it is necessary to arrange the pointer displayed on the screen in the menu indications or individual menu at all times. For that reason, an operation of selecting menu is complicated. For example, when the input pad is operated using a plurality of the menu indications displayed on the menu bar, a menu other than the desired pull-down menu may be inadvertently opened because the pointer may not be arranged in the location of the menu indication.

According to an aspect of the invention, an input device permits easy and precise selection of the menu indications in the menu bar or selection of the pull-down menus by enabling the input pad to be operated in the menu select mode.

According to one embodiment of the invention, an input device includes an input pad detecting operations of an operator from a variation in capacitance, a detection unit detecting an operating location of the operator on the input pad, and a processing unit processing a detection signal detected by the detection unit. The processing unit recognizes a part of a region on an input surface of the input pad as a menu open region, and outputs a menu operation signal for displaying menu contents corresponding to menu indications in a display image displayed on a screen on the basis of an application program when it is detected that the menu open region is operated by the operator. The processing unit also outputs a selection signal for selecting an individual menu among the menus when a movement of the operator on the input surface is detected.

In the input device, the menu content corresponding to the menu indication may be displayed by allowing the operator to touch the menu open region set on the input surface of the input pad. Therefore, it is unnecessary to arrange the pointer on the screen in the location of the menu indication by operating the input pad. In addition, when any one of the menu contents is displayed, the individual menu among the menus may be selected by moving the operator on the input pad. In such case, it is also unnecessary to arrange the pointer in the location of the each individual menu. Therefore, it is possible to easily and precisely select the individual menu because it is unnecessary to arrange the pointer in the small region of the menu indications or the individual menus.

The processing unit may output an execution signal for executing a program corresponding to the selected individual menu when the input pad is tapped in a state where any one of the individual menus is selected. Otherwise, the processing unit may output an execution signal for executing a program corresponding to the selected individual menu when a key input unit, other than the input pad, is pressed in the state where any one of the individual menus is selected.

In case of executing a program after selecting an individual menu, since it is unnecessary to fix a pointer on the individual menu the program corresponding to the individual menu may be precisely activated.

In the input pad, the number of the menu open regions corresponding to the number of the menu indications indicated in the display image can be arranged in the same direction as the arrangement direction of the menu indication. When it is detected that any one of the menu open regions is operated by the operator, the menu content of the menu indication located in the location corresponding to the operated menu open region is displayed.

In the input device, it is possible to select any one of a plurality of the menu indications and display the menu content corresponding to the menu indication by operating any one of a plurality of the menu open regions with the finger.

When the operating location of the operator is moved in the arrangement direction of the menu open region in the state where the menu content corresponding to any one of the menu indications is displayed, the menu content corresponding to another menu indication may be displayed.

In such the device, it is possible to display the menu content corresponding to another menu indication only by moving the operator such as the finger in the state where the menu corresponding to any one of the menu indications is displayed.

When it is detected that the input surface is operated by the operator in the direction intersecting the arrangement direction of the menu open region in the state where the menu content corresponding to any one of the menu indications is displayed, it is preferred that the selection signal for selecting the individual menu out of the displayed menus is outputted.

In the input device, when the menu content corresponding to any one of the menu indications is displayed, the individual menu may be selected by moving the finger back and forth. In such a case, the respective individual menus may be precisely sequentially selected by using almost all the regions of the input pad, even if a plurality of individual menus are arranged in a narrow pitch on the screen. In such the case, it is also unnecessary to arrange the pointer in the small region of the individual menus.

The processing unit is changed to a menu select mode when it is detected that the menu open region is operated, and is configured to let the pointer displayed on the screen not to be moved even the input surface is operated by the operator in the state where the processing unit is set to the menu select mode.

That is, the input device performs operation in an exclusive mode of the menu select mode when the menu open region is operated. Therefore, it is unnecessary to arrange the pointer in the menu indications or individual menu when performing the same operation as the mouse input device used in the past.

In such case, for example, it is preferred that the menu select mode is cancelled by pressing the key input unit other than the input pad. The menu select mode may be precisely cancelled by operating the key input unit.

In addition, according to one embodiment of the invention, a computer system includes any one of the input devices of the invention, an operating system receiving signals from the processing unit, and a display unit displaying the display image under the control of the operating system.

In the input device and the computer system employing the input device according to the embodiments of the invention, selecting of the menu indications in the display image, such as the activated window or selecting of the individual menus, may be easily and precisely performed by using the capacitance type input pad. In addition, it is unnecessary to arrange the pointer in the location in which the menu indications or the individual menus are displayed, and selecting the menu indications or the individual menus arranged in the plural numbers can be precisely performed with less error.

### BRIEF DESCRIPTION OF THE DRAWINGS

FIG. 1 shows an input device and a computer system according to a first embodiment of the invention. FIG. 1A is a pictorial view showing one example of a display image displayed on a display screen. FIG. 1B is a plane view showing an input pad, an L key input unit, and an R key input unit.

FIGS. 2A and 2B show the input device and the computer system according to the first embodiment of the invention. FIG. 2A is a pictorial view showing a menu displayed on a display screen. FIG. 2B is a plan view showing an input pad, an L key input unit and an R key input unit, which describe an operation when displaying the menu picture.

FIGS. 3A and 3B show an input device and a computer system according to a second embodiment of the invention. FIG. 3A is a pictorial view showing a display screen image, and FIG. 3B is a plan view showing an input pad, an L key input unit, and an R key input unit.

FIG. 4 is a block diagram showing configurations of the input device and the computer system.

FIG. 5 is a flow chart showing a processing operation of the input device and the computer system according to the first embodiment of the invention.

FIG. 6 is a flow chart showing a processing operation of the input device and the computer system according to the first embodiment of the invention.

### DESCRIPTION OF THE PREFERRED EMBODIMENT

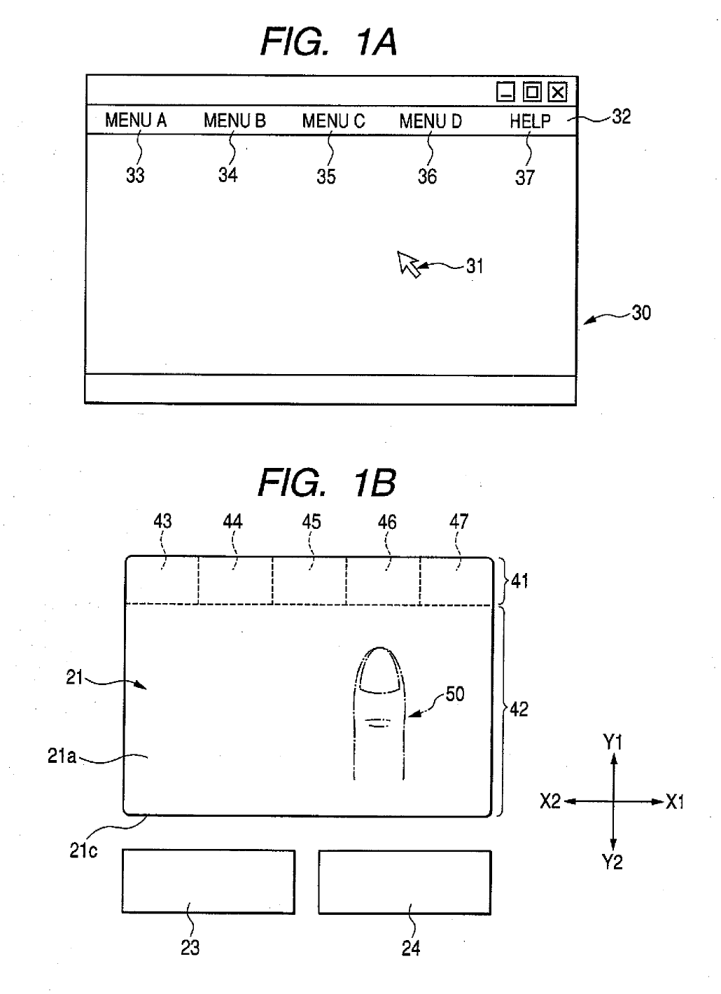

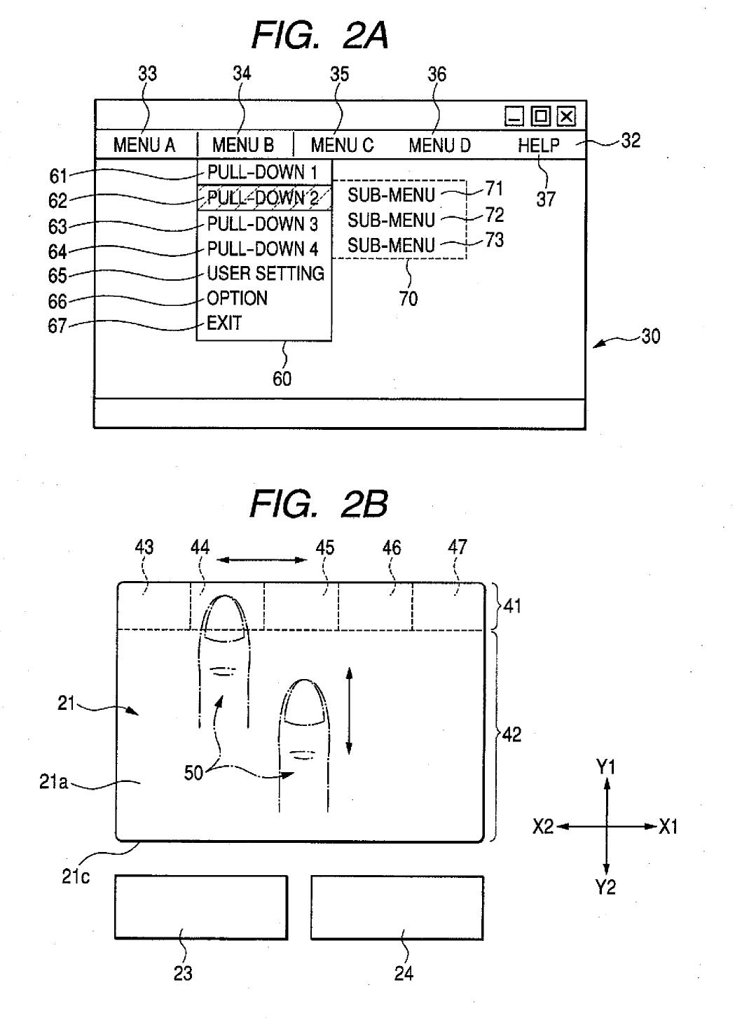

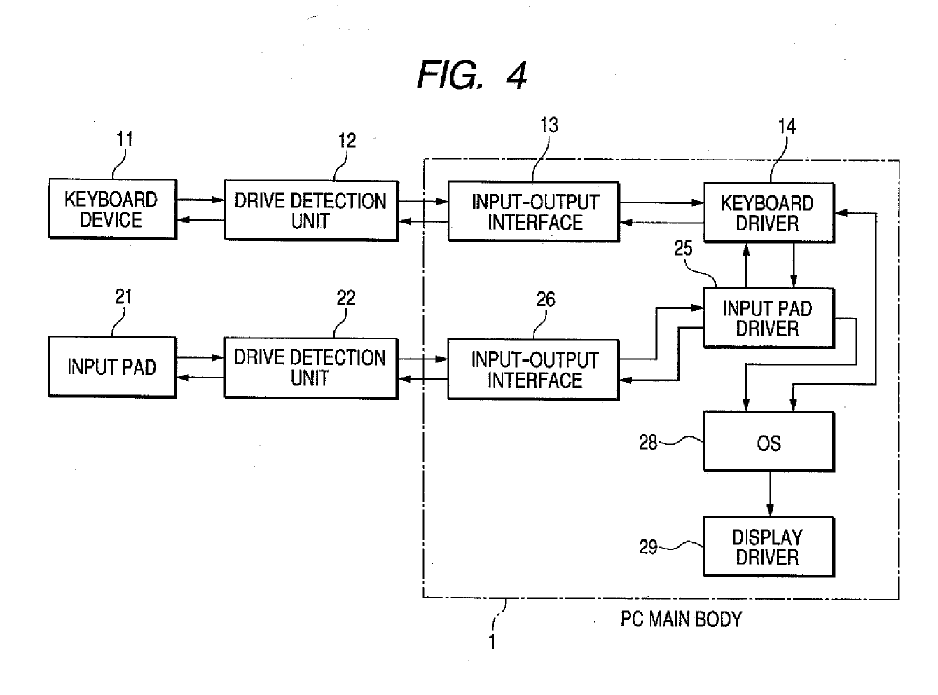

FIG. 1A shows one example of a display image displayed on a screen of a computer system according to a first embodiment of the invention. FIG. 1B is a plan view showing an input pad, an L key input unit, and an R key input unit, which are disposed in a front side of a keyboard device. FIG. 2A shows a menu displayed according to the first embodiment of the invention, and FIG. 2B is a plan view showing operation of the input pad when displaying the menu picture. FIG. 4 is a block diagram showing configurations of the input device and the computer system.

The computer system shown in FIG. 4 includes a PC main body 1, a keyboard device 11, and a capacitance type input pad 21.

The keyboard device 11 includes a plurality of key input units arranged vertically and horizontally. Each key input unit includes a push button and a key switch converted from OFF state to ON state by pressing the push button. In addition, a drive detection unit 12 is provided in the keyboard device 11. The drive detection unit 12 includes a power supply circuit that supplies a voltage to the key switches and a detection circuit that detects an electric current when any one of the key switches change from and OFF state to an ON state. The drive detection unit also includes a CPU, which recognizes the key switch change to an ON state, generates a predetermined formatted signal by the use of a unique code, and transmits the signal to the PC main body 1.

A keyboard driver 14 is provided in a control unit which includes the CPU and a memory inside of the PC main body 1. The keyboard driver 14 is software installed in the control unit. The drive detection unit 12 and the keyboard driver 14 are connected to each other through an input-output interface 13, such as USB or the like. The keyboard driver 14 repeatedly polls the drive detection unit 12 at regular intervals and the drive detection unit 12 responds to the polling and transmits the formatted signal to the keyboard driver 14.

The input pad 21 detects a variation in capacitance between electrodes. A plurality of X electrodes are provided parallel with each other on one surface of an insulating substrate having a predetermined permittivity, and a plurality of Y electrodes disposed perpendicular to the X electrodes are provided parallel with each other on the other surface of the insulating substrate. Detecting electrodes are formed between neighboring X electrodes or neighboring Y electrodes. A plurality of the detecting electrodes are provided parallel with each other at even intervals between the neighboring X electrodes or the neighboring Y electrodes. A cover, such as a resin film, is provided on the outermost surface of the input pad 21.

A drive detection unit 22 is provided in the input pad 21. The drive detection unit 22 includes an “X driver” sequentially selects the X electrodes, and supplies electric potential to the selected X electrodes and grounding potential to the non-selected X electrodes. A “Y driver” sequentially selects they electrodes with timing different from the selection of the X electrodes, and supplies electric potential to the selected Y electrodes and grounding potential to the non-selected Y electrodes.

In addition, the drive detection unit 22 includes a detection circuit which detects a variation in capacitance between the X or Y electrodes according to the voltage variation between the electrodes when a finger touches the cover. The CPU provided in the drive detection unit 22 specifies a location where an operator is touched on the X-Y coordinates on the basis of information about whether the X electrodes or the Y electrodes are selected, and a detection value of the voltage variation in between the selected electrodes and the detecting electrodes. On the basis of the result, the CPU generates a predetermined formatted detection signal, which contains location data of X coordinate and location data of Y coordinate. The signal is then outputted in a format provided by the drive detection unit 22.

The input pad 21 shown in FIG. 1B is provided in a front side of the keyboard device 11 of an operating panel of a computer system. In front of the input pad 21, there are provided an L key input unit 23 at the left and an R key input unit 24 at the right as the key input units. Both of the L key input unit 23 and the R key input unit 24 have a push button and a key switch converted from OFF state to ON state when the push button is pressed. Detection outputs from the key switches are transmitted to the drive detection unit 22. To the detection data (detection signal) outputted from the drive detection unit 22, operation signals from the L key input unit 23 and the R key input unit 24 are added in addition to the location data of X coordinate and the location data of Y coordinate.

As shown in FIG. 4, an input pad driver 25 is provided in the control unit, which includes the CPU and a memory inside of the PC main body 1. The input pad driver 25 is software installed in the control unit. The input pad drive detection unit 22 and the input pad driver 25 are connected to each other through the input-output interface 26, such as a universal serial bus (USB) or the like. The input pad driver 25 repeatedly polls for the drive detection unit 22 at regular intervals and then the drive detection unit 22 responds to the polling and transmits the formatted signal to the input pad driver 25. The keyboard driver 14 and the input pad driver 25 are operated in connection with each other.

As shown in FIG. 4, a predetermined standardized operating system (OS) 28 is provided. The OS 28 is software installed in the control unit. In the PC main body 1, a storage unit is provided in which various application programs are installed and stored. The application programs stored in the storage unit are selected by the OS 28, and actuated and executed by the OS 28.

In the PC main body 1, a display unit includes a display screen, such as a liquid crystal display device or the like. A display driver 29 provided inside the PC main body 1 is controlled by the OS 28 and a display image is displayed on the display screen by the display driver 29.

According to the embodiment of the invention, the keyboard driver 14, the input pad driver 25, and the OS 28 serve as a processing unit, which processes the detection data (detection signal) obtained from the drive detection unit 12 or the drive detection unit 22. An input device includes the keyboard device 11, the drive detection unit 12, the input pad 21, the drive detection unit 22, the input-output interfaces 13 and 26, the keyboard driver 14, and the input pad driver 25.

FIG. 1A shows one example of a display image 30 displayed on a screen. The display image 30 is displayed by the display driver 29 under the control of the OS 28. In addition, a pointer 31 is displayed on the display screen.

When an input surface 21a of the input pad 21 is operated with a finger 50, a mouse control signal is provided from the input pad driver 25 to the OS 28. When the drive detection unit 22 detects that the finger 50 touches the input surface 21a in the general coordinates input mode, a location where the finger 50 touches is recognized as a location of absolute coordinates on the X-Y coordinates.

Therefore, in respond to the polling from the input pad driver 25, the detection data (detection signal) corresponding to the absolute coordinates is transmitted to the input pad driver 25. The detection date includes location data of X coordinate and location data of Y coordinate, which indicates the location where the finger 50 touches. In the general coordinates input mode, the detection data of the data of the absolute coordinates is converted to the mouse control signal of data of relative coordinates, and is transmitted to the OS 28. The data of the relative coordinates indicates the direction in which to be moved and the distance to be moved when the finger 50 slides on the input surface 21a.

When the signal of the relative coordinates is transmitted to the OS 28, the display driver 29 is controlled on the basis of the signal, and the pointer 31 displayed on the display screen is moved. The direction which the pointer 31 is to be moved in is determined according to the direction which the finger 50 is moved along the input surface 21a. The distance which the pointer 31 is to be moved is determined according to the distance which the finger 50 moves along the input surface 21a.

In order to select respective menu indications 33, 34, 35, 36, and 37 displayed in a menu bar 32 when the input pad driver 25 is operated in the general coordinates input mode, the finger 50 slides on the input surface 21a. This moves the pointer 31 and places the pointer 31 in the location where the menu indication to be selected overlaps. After that while keeping the pointer 31 at the location of the selected menu indication without moving the finger 50, the finger 50 taps the input surface 21a (the finger quickly touches the input surface 21a and is removed immediately.) Otherwise, the L key input unit 23 is operated. By such an operation, the menu picture corresponding to the selected menu indication can be displayed.

In such the input device and the computer system, the input pad driver 25 can be operated by setting an operation mode thereof as a ‘menu select mode.’ In order to make the input pad driver operate in the menu select mode, a ‘menu open region group 41’ is set as an area in a predetermined section on the input surface 21a.

A setting picture of a control panel is displayed on the display screen and the input pad driver 25 is actuated to display a management picture of the input pad driver 25. While keeping the management picture displayed, the keyboard device 11 is operated or the input pad 21 being operated in the general coordinates input mode with the finger 50 to enter a mark on a selection field of the ‘menu select mode.’ In addition, the selection item to select is inputted to determine whether the menu open region group 41 is to be set in the region along the upper edge 21b of the input surface 21a or in the region along the lower edge 21c of the input surface 21a.

FIG. 1B shows a menu open region group 41 set in the region along the upper edge 21b of the input surface 21a. The menu open region group 41 is set in the entire area in the X direction along the upper edge 21b of the input surface 21a. Then, a region other than the menu open region group 41 becomes an operation region 42 on the input surface 21a. The width of the operation region 42 in the Y direction is set to be wider than the width of the menu open region group 41 in the Y direction. In the management picture, the width of the menu open region group 41 in the Y direction may be arbitrarily changed.

When the menu open region group 41 is set as an area, the menu open region group 41 is used as an exclusive area for setting the ‘menu select mode’. Provided that the ‘menu select mode’ is not set, when the operation region 42 is operated with the finger 50, the input pad driver 25 is operated in the general coordinates input mode. Further, when the finger 50 which touches the operation region 42 and slides thereon, the pointer 31 displayed on the display screen is correspondingly moved in the direction which the finger slides in accordance with the distance which the finger slides. In addition, provided that the ‘menu select mode’ is not set, when the operation region 42 is tapped with the finger 50, the detection data is generated which is the same as the data obtained by operating a click button of the mouse input device.

As shown in FIG. 1B, the menu open region group 41 is divided into a plurality of the menu open regions 43, 44, 45, 46, and 47. As shown in the FIG. 1A, those sections are automatically set by actuating the application program and activating the display image (window) 30 on the display screen.

Provided that menu select mode is set, and the menu open region group 41 is set as an area in the management picture, when any one of the application programs are activated and the display image 30 displayed on the display screen is activated, information on the activated display image 30 is provided from the OS 28 to the input pad driver 25. The input pad driver 25 allocates a plurality of the menu open regions inside the menu open region group 41 on the basis of the information. When the display image 30 shown in FIG. 1A is activated, five sections of menu indications 33, 34, 35, 36, and 37 are displayed in the menu bar 32. For that reason, as shown in FIG. 1B, the menu open regions 43, 44, 45, 46, and 47 divided into five sections are set in the menu open region group 41 of the input pad 21.

Since the absolute coordinates are provided from the input pad 21 to the input pad driver 25, every location on the input surface 21a of the input pad 21 can be recognized as the X-Y coordinates in the input pad driver 25. Accordingly, for example, when the finger 50 touches the menu open region 43 on the input surface 21a of the input pad 21, the location where the finger 50 touches is recognized as the data of the absolute coordinates on the X-Y coordinates in the input pad driver 25. Then, the coordinates of the section where the finger 50 touches is analyzed, and it is recognized that the finger 50 has touched the menu open region 43.

The number of the menu indications set in the menu bar 32 of the display image 30 and the number of the menu open regions divided into the menu open region group 41 are the same. For example, when the number of the menu indications in the display image 30 is set to eight, the number of sections of the menu open regions in the menu open region group 41 is set to eight at the time that the display image (window) is activated.

As described above, when the display image (window) 30 is being activated, the operation region 42 is used in the general coordinates input mode as long as the finger 50 does not touch the menu open region group 41.

FIGS. 2A and 2B shows a state where the input pad driver 25 is operated in the menu select mode. In FIGS. 2A and 2B, a state where the menu select mode is set by operating the menu open region 44 disposed at the second from the left in the menu open region group 41 on the input surface 21a, and a menu picture 60 corresponding to the menu indications 34 disposed at the second from the left is displayed in the display image 30, is shown.

The menu select mode is set so that when the finger 50, which touches the input surface 21a, is moved to any one of the menu open regions, the finger 50 is removed from the menu open region, and then the menu select mode is set when a certain time (for example, approximately 0.1 to 1 sec) is passed after removing the finger. Otherwise, the menu select mode is set in a manner that the finger 50 which touches the input surface 21a is moved to any one of the menu open regions, and then the finger is stopped at the location for a certain time (for example, approximately 1 sec). In other way, the menu select mode is set in a manner that the finger taps once (one-tapping operation) or twice (double-tapping) any one of the menu open region.

When the menu select mode is set, the menu select mode is continuously carried out without being canceled as long as a canceling operation is not carried out. The canceling operation is carried out, for example, by pressing the push button of the R key input unit 24. Otherwise, the menu select mode may be canceled by operating any one push button of the L key input unit 23 and the keyboard device 11. In other way, the menu select mode may be selected by tapping the menu open region 44 once and the menu select mode may be canceled by double-tapping the menu open region 44.

When the menu select mode is set, a menu operation signal is outputted from the input pad driver 25 to the OS 28, and a menu picture corresponding to the selected menu indication is displayed under the control of the OS 28. When the menu select mode is set by operating the menu open region 43 on the input surface 21a with the finger 50, the menu picture 60 corresponding to the menu indication 33 displayed. In addition, when the menu select mode is set by operating the menu open region 44 with the finger 50, the menu picture 60 corresponding to the menu indication 34 disposed at the second from the left in the display image 30 is displayed. As mentioned above, the menu open regions 43, 44, 45, 46, and 47 set on the input surface 21a, and the menu indications 33, 34, 35, 36, and 37 in the display image 30, have a one-to-one correspondence. An example in which the menu select mode is set by operating the menu open region 44 and the menu picture 60 corresponding to the menu indication 34 is displayed, will be described below.

The menu picture 60 is continuously displayed until the menu select mode is canceled. Further, the menu picture 60 is continuously displayed even if the finger is removed from the menu open region 44 as long as the menu select mode is not canceled.

The menu picture 60 is referred as a pull-down menu or a drop-down menu. A plurality of the individual menus 61, 62, 63, . . . , and so on are displayed in the menu picture 60. In FIG. 2A, the menu indications 33, 34, 35, . . . , and so on are marked as ‘menu A’, ‘menu B’, and the like. However, the menu indications 33, 34, 35, . . . , and so on are displayed as ‘file’, ‘edit’, ‘view’, ‘format’, ‘tool’, ‘help’, and the like in the actual display image (window) 30. In addition, in FIG. 2A, the individual menus 61, 62, 63, . . . , and so on displayed in the menu picture 60 are marked as ‘pull-down 1’, ‘pull-down 2’, ‘pull-down 3’ . . . , and so on. However, in the actual display image 30, the individual menus 61, 62, 63, . . . , and so on correspond to the menu indications. For example, when the menu indication 34 is ‘edit’, items such as ‘input’, ‘paste’, ‘find’, ‘displacement’, ‘jump’, ‘input Japanese’, ‘user setting’, ‘option’, ‘exit’, and the like, are displayed as individual menus 61, 62, 63, . . . , and so on.

When the input pad driver 25 is set in the menu select mode, for example, the pointer 31 displayed on the display screen is automatically moved to the location where the selected menu indication 34 is overlapped. For a period that the menu select mode is set (a period that the menu picture 60 is displayed), a location of the pointer 31 is not moved even when the finger 50 touches the operation region 42 and slides on the operation region 42. That is, when the menu select mode is set, the detection data obtained when the finger 50 slides on the operation region 42 is not treated as the general input data of the coordinates in the input pad driver 25 until the menu select mode is canceled.

Next, provided that the menu picture 60 is displayed, when the finger 50 slides along the operation region 42 on the input surface 21a in the direction intersecting the arrangement direction of the menu open regions 43, 44, 45, 46, and 47′ preferably in the Y direction perpendicular to the arrangement direction of the menu open regions, the individual menus in the menu picture 60 are sequentially selected. When any one of the individual menus is selected, the selection signal for selecting the individual menu is provided from the input pad driver 25 to the OS 28. The selected individual menu is displayed highlighted with a color or density which can be distinguished from the other individual menus under the process of the OS 28. For example, when the finger 50 slides on the operation region 42 in the Y2 direction, the individual menu in the menu picture 60 is sequentially selected from the uppermost individual menu 61 downwards. When the finger 50 slides in the Y1 direction, the individual menu in the menu picture 60 is sequentially selected from the lowermost individual menu 67 upwards.

At this time, data of the absolute coordinates on the X-Y coordinates detected at the input pad 21 when the finger 50 slides thereon is recognized in the input pad driver 25 as data of the relative coordinates detected when the finger 50 slides in the Y direction. Accordingly, even when the finger 50 is moved in the Y direction from any sections of the operation region 42 as the starting point, the individual menus can be sequentially selected. Since such an operation of selecting the individual menus is carried out in a manner that the finger 50 touches any one of the sections in the operation region and slides in the Y direction, the individual menus can be quickly and precisely selected as compared with the operation in which the individual menus are selected in the general coordinates input mode. That is, the individual menus are selected by arranging the pointer to the each location of the individual menus.

When any one of the individual menus 61, 62, 63, . . . , and so on is selected and highlighted, the highlighted display of the selected individual menu, that is, a state where the individual menu is selected is continued even the finger 50 is removed from the operation region 42. When the finger 50 is removed from the operation region 42 and then the finger 50 touches the operation region 42 again and slides in the Y1 direction in the state where any one of the individual menus is selected, the individual menu which has been selected is set as the starting point, and the individual menus arranged upward of the selected individual menu are sequentially selected from the bottom. On the contrary, when the finger 50 slides again in the Y2 direction, the individual menu which has been selected is set as the starting point, and the individual menus arranged downward of the selected individual menus are sequentially selected from the top.

Next, in case of executing a program corresponding to the selected individual menu, the L key input unit 23 is pressed in the state where the selected individual menu is highlighted displayed. Otherwise, the R key input unit 24 or any one of the key input units of the keyboard device 11 is pressed. In other way, the program corresponding to the individual menu can be executed by tapping once or by double-tapping any one section in the operation region 42 with the finger 50. When such an execution operation is carried out, an execution signal is provided from the input pad driver 25 to the OS 28, and the program corresponding to the selected individual menu is executed under the process of the OS 28. Due to the execution of the program, the menu select mode setting is canceled in the input pad driver 25.

As shown in FIG. 2A, for example, an operation of opening the menu pictures corresponding to the other menu indications in the state where the menu picture 60 corresponding to the menu indication 34 is displayed, can be carried out in a manner that the finger 50 touches the other menu open regions divided in the menu open region group 41 on the input surface 21a without canceling the menu select mode.

For example, provided that the menu picture 60 corresponding to the menu indication 34 is displayed, when the finger 50 is moved more than the predetermined distance in the X1 direction in the menu open region group 41, the menu picture 60 corresponding to the menu indication 35 disposed at right side is displayed instead. Further, when the finger 50 is moved more than the predetermined distance in the X1 direction in the menu open region group 41, the menu picture 60 corresponding to the menu indication 36 is displayed instead. As mentioned above, the menu picture is converted to the menu picture 60 corresponding to the different menu indications and sequentially displayed. In addition, when the finger 50 is moved in the X2 direction in the menu open region group 41, the menu picture is converted to the menu picture 60 corresponding to the menu indication disposed at the left side of the menu indication corresponding to the menu picture currently displayed, and sequentially displayed.

Otherwise, as shown in FIG. 2A, when the menu picture 60 corresponding to the menu indication 34 is displayed, the menu picture may be converted to the menu picture 60 corresponding to the menu indication 35 and displayed in a manner that the finger 50 taps once (one-tapping operation) or twice (double-tapping) the other menu open regions, for example, the menu open region 45.

As shown in FIG. 2A, the sub-menu corresponding to any one of the individual menus can be selected in the state where the menu select mode is set and the menu picture 60 is displayed. In FIG. 2A, there is exemplified that a sub-menu picture 70 corresponding to the individual menu 62 disposed at the third from the top is displayed.

The sub-menu picture 70 is automatically displayed only when the individual menu 62 is selected by the above-mentioned operation accompanying the highlighted display of the individual menu 62. In case of selecting the sub-menus 71, 72, and 73 in the sub-menu picture 70, the finger 50 slides on the operation region 42 in the X1 direction by the predetermined distance in the state where the sub-menu picture 70 is displayed. By such an operation, the sub-menu 71 disposed at the uppermost of the sub-menu picture 70 is selected, a sub-menu selection signal is provided from the input pad driver 25 to the OS 28, and the selected sub-menu 71 is displayed highlighted with a color or density which can be distinguished from the other menus under the process of the OS 28. In case of selecting the other sub-menus in the sub-menu picture 70, the finger 50 which touches the operation region 42 slides in the Y2 direction. By such an operation, the sub-menu is sequentially selected in order of 71, 72, and 73 from upside to downside in the sub-menu picture. When the finger 50 slides in the Y1 direction in the middle of the operation, the sub-menu is sequentially selected upwards. An operation of executing a program corresponding to the selected sub-menu is the same as the execution operation of the programs corresponding to the individual menus.

When stopping the operation of selecting the sub-menu in the sub-menu picture 70 and re-starting the operation of selecting the individual menu in the menu picture 60, the finger 50 slides on the operation region 42 in the X2 direction. By such an operation, the individual menu 62 adjacent to the sub-menu picture 70 is selected again and highlighted displayed.

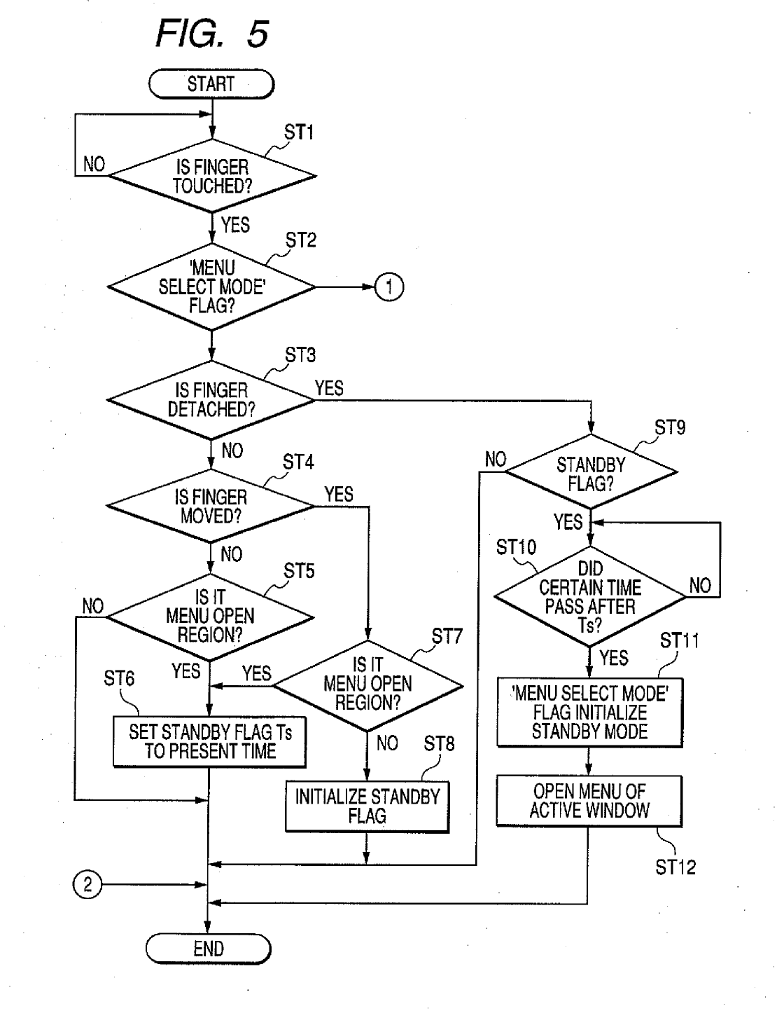

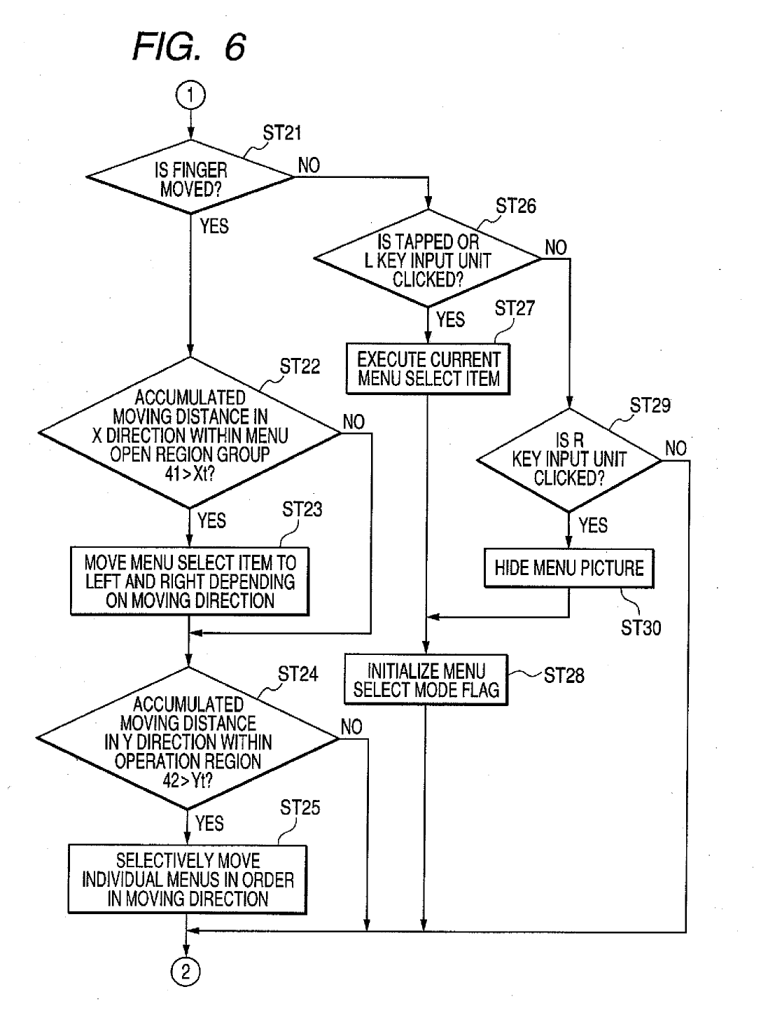

FIGS. 5 and 6 show examples of control flow charts when carrying out operations, such as the above-mentioned setting of the menu select mode, selecting of the individual menu, or the like. The software according to the flow charts is executed under the control of a processing unit, that is, the input pad driver 25 and the OS 28. In the FIGS. 5 and 6, ‘step’ is indicated by ‘ST’.

In ST1 shown in FIG. 5, whether the finger 50 touches any one section on the input surface 21a of the input pad 21 is monitored. When the detection data that the finger 50 touches any one section on the input surface 21a is obtained from the drive detection unit 22 according to the polling provided from the input pad driver 25 to the drive detection unit 22, ST2 is performed. In ST2, whether a flag of the ‘menu select mode’ is currently set, that is, the ‘menu select mode’ is set and the menu picture 60 is currently displayed is determined. When it is determined that the menu select mode is not set, whether the finger 50 is removed from the input surface 21a is monitored in ST3. When it is determined that the finger is not removed, whether a location where the finger 50 is attached is moved, is monitored in ST4.

When it is determined in ST4 that the finger 50 is not moved, whether the region where the finger 50 touches is any one of the menu open regions 43, 44, 45, 46, and 47 is determined in ST5. When it is determined in ST5 that the finger 50 does not touch the menu open regions, that is, when it is determined that the ‘menu select mode’ is not set and the finger 50 touches the operation region 42, the process is ended. In this step, when the detection data is provided from the drive detection unit 22 to the input pad driver 25 on the basis of a contact of the finger 50 and a sliding operation, the data is processed in the general coordinates input mode in the input pad driver 25.

When it is determined in ST5 that the finger 50 touches any one of the menu open regions 43, 44, 45, 46, and 47, the standby mode is set (standby flag is set) and the count time Ts is set to the present time in ST6, thereby ending the process.

When the detection data is provided from the drive detection unit 22 to the input pad driver 25 according to the next polling, and when it is determined that the menu select mode is not set in ST2, the finger 50 is not removed from the input surface 21a in ST3, and the finger 50 is moved in ST4, ST7 is performed. In ST7, whether the moved finger 50 touches the menu open regions 43, 44, 45, 46, and 47 is determined, and when it is determined that the finger 50 touches the operation region 42 other than the menu open regions, the standby mode is canceled in ST8, thereby ending the process. In addition, when it is determined in ST7 that the moved finger 50 touches the any one of the menu open regions, the standby mode is set and the count time Ts is set to the present time in ST6.

When the detection data is obtained from the drive detection unit 22 according to the polling from the input pad driver 25 and when it is determined that the menu select mode is not set in ST2 and the finger 50 is removed from the input surface 21a in ST3, ST9 is performed. In ST9, whether the standby mode is set at that time is determined and when it is determined that the standby mode is not set, the process is ended. When it is determined in ST9 that the standby mode is set, ST10 is performed.

In ST10, whether a certain time (for example, approximately 0.1 to 1 sec) is passed after the count time Ts is counted. When the certain time is passed, the ‘menu select mode’ is set (flag of the menu select mode is set) and also the standby mode is initialized in ST11. After that, as shown in FIG. 2A, it is determined that the menu indication corresponding to the menu open region where the finger 50 is located is selected and then the menu picture 60 corresponding to the selected menu indication is displayed in ST12.

When the detection data is obtained from the drive detection unit 22 according to the polling from the input pad driver 25 and the menu select mode is set (menu picture 60 shown in FIG. 2A is displayed) in ST2, ST21 of FIG. 6 is performed.

In ST21, whether the finger 50 which touches the input surface 21a is moved is determined, and when it is detected that the finger 50 is moved, ST22 is performed. Whether the finger 50 is moved in the X direction by a distance longer than the predetermined threshold Xt in the menu open region group 41 is determined in ST22. When it is determined that the finger 50 is moved in the X direction by a distance longer than the threshold Xt in the menu open region group 41, the menu picture 60 corresponding to the other menu indication located in the moving direction is displayed in ST23, depending on the movement whether it is in the X1 direction or the X2 direction.

For example, when the finger 50 slides in the X1 direction from the menu open region 44 and is moved to the next menu open region 45, the menu picture 60 corresponding to the menu indication 34 is removed and the menu picture 60 corresponding to the next menu indication 35 is displayed instead. Further, when the finger 50 is moved to the next menu open region 46, the menu picture 60 corresponding to the menu indication 35 is immediately removed and the menu picture 60 corresponding to the next menu indication 36 is opened instead. As mentioned above, the menu picture is sequentially converted in the right direction and displayed. Even when the finger 50 is moved in the X2 direction, the menu picture is displayed in the same manner as above.

When the detection data is obtained from the drive detection unit 22 according to the next polling and when it is determined that the finger 50 does not move in the X direction by a distance longer than the predetermined threshold Xt in the menu open region group 41 in ST22, ST24 is performed. In ST 24, whether the finger 50 which touches the operation region 42 is moved in the Y direction by a distance longer than the predetermined threshold Yt in the operation region is determined. When it is detected in ST24 that the finger 50 is moved in the Y direction by a distance longer than the threshold Yt in the operation region 42, the individual menu in the menu picture 60 shown in FIG. 2A is selected in ST25.

When it is detected that the finger 50 is moved in the Y2 direction, the individual menus are highlighted displayed in order of 61, 62, 63, . . . , and so on in the menu picture 60 depending on the moving distance. On the contrary, when it is detected that the finger 50 is moved in the Y1 direction, the individual menus are highlighted displayed in order of 67, 66, 65, . . . , and so on depending on the distance moved. After that, a process according to the polling is ended.

In ST 21, when it is detected that a location where the finger 50 is attached is not moved for a certain time in the state where the menu select mode is set, it is determined that any one of the individual menus are selected, and ST 26 is performed. In ST26, whether the operation of executing the program corresponding to the selected individual menu is carried out is determined by the detection data from the drive detection unit 22 according to the next polling. Here, when either an operation of one-tapping any one section on the input surface 21a with the finger 50 or an operation of pressing the L key input unit 23 is detected, it is determined that the operation of executing the program is carried out, and ST27 is performed. In ST27, the program corresponding to the individual menu which is selected at that time is executed. Such a processing is executed by calling the state where the input pad driver 25 detects that the execution operation has been carried out to the OS 28.

When the program corresponding to the selected individual menu is executed, the setting of the menu select mode is automatically canceled in ST28, thereby ending the process.

When an operation of executing the program corresponding to the selected individual menu is not carried out in ST26, it is detected in ST29 whether the menu select mode is canceled. Here, when the R key input unit 24 is operated, it is determined that the menu select mode is canceled and ST30 is performed. A process for erasing the display of the menu picture 60 is carried out in ST30 and simultaneously ST 28 is performed, thereby canceling the setting of the menu select mode.

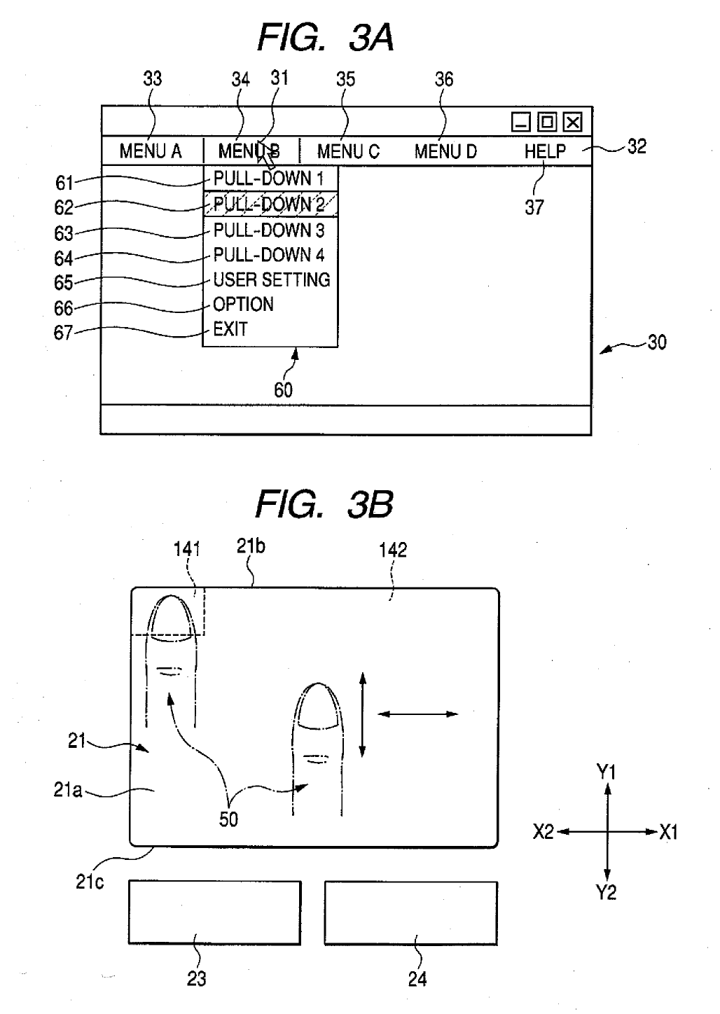

FIG. 3 shows a second embodiment of the invention. FIG. 3A is one example of the display image (window) 30 displayed in the display screen, and FIG. 3B is a plane view showing an input pad 21, an L key input unit 23, and an R key input unit 24.

The display image 30 shown in FIG. 3A are the same as the first embodiment of the invention. The input pad 21 shown in FIG. 3B is also the same as the first embodiment of the invention but the area set as the menu open region is different from the first embodiment of the invention.

According to the second embodiment of the invention, one menu open region 141 is set as an area in any one section of the input surface 21a when the menu select mode is set by calling the management picture of the input pad driver 25. In FIG. 3B, the menu open region 141 is set with a relatively small area at the upper left corner of the input surface 21a. The menu open region 141 may be set as an area at the other corners of the input surface 21a, any one region inside of the upper edge 21b of the input surface 21a, or any one region inside of the lower edge 21c of the input surface 21a.

The location and the area of the menu open region 141 can be freely set on the management picture. On the input surface 21a, the region other than the menu open region 141 is set to be an operation region 142. The area of the operation region 142 is set to be sufficiently wider than the area of the menu open region 141.

In an input device and a computer system according to the second embodiment of the invention, when the operation region 142 is operated with the finger in the state where the menu select mode is not set, the input pad driver 25 processes the operation in the general coordinates input mode on the basis of the detection data provided from the drive detection unit 22.

When a certain period of time (for example, approximately 0.1 to 1 sec) has passed after the finger 50 touches the menu open region 141 on the input surface 21a and then the finger 50 is removed, the menu select mode is set. Otherwise, the menu select mode is set when a certain period of time (for example, approximately 1 see) has passed in the state where the finger 50 is attached in the menu open region 141; or the menu select mode is set by tapping the menu open region 141 with the finger 50.

When the menu select mode is set, the menu picture 60 is displayed. However, at that time, the menu picture 60 corresponding to any one of a plurality of the menu indications 33, 34, 35, 36, and 37 which is previously determined is displayed. For example, the menu picture 60 corresponding to the menu indication 33 located at the leftmost is automatically displayed. The menu select mode is continued and the display of the menu picture 60 is continued as long as the menu select mode is not canceled in the same manner in the first embodiment of the invention.

A follow-up process is as follows. The individual menus 61, 62, 63, . . . , and so on in the menu picture 60 are sequentially selected when the finger 50 touches any one section of the operation region 42 and the finger 50 slides in the Y direction. When the finger 50 touches any one section in the operation region 42 and slides in the X direction, the menu picture 60 corresponding to the menu indication 34 adjacent to the menu indication 33 currently displayed in the menu picture 60 is displayed. Depending on the moving distance in the X direction of the finger 50, it is converted to display the menu picture 60 corresponding to any one of the menu indications.

In addition, an execution of the program corresponding to the selected individual menu, an execution of the program corresponding to the selected sub-menu, and operations of canceling the setting of the menu select mode are also carried out in the same manner in the first embodiment of the invention.

The terms and descriptions used herein are set forth by way of illustration only and are not meant as limitations. Those skilled in the art will recognize that many variations can be made to the details of the above-described embodiments without departing from the underlying principles of the invention. The scope of the invention should therefore be determined only by the following claims (and their equivalents) in which all terms are to be understood in their broadest reasonable sense unless otherwise indicated.

What is claimed is:

1. An input device comprising:
an input pad configured to detect operations of an operator by detecting a variation in capacitance;
a detection unit configured to detect an operating location of the operator on the input pad; and
a processing unit adapted to process a detection signal transmitted by the detection unit,
wherein, the processing unit recognizes a part of a region on an input surface of the input pad as a menu open region, outputs a menu operation signal for displaying menu contents corresponding to menu indications in a display image displayed on a screen on the basis of an application program when it is detected that the menu open region is operated by the operator, and outputs a selection signal for selecting an individual menu among the menus when a movement of the operator on the input surface is detected.

2. The input device according to claim 1, wherein the processing unit outputs an execution signal for executing a program corresponding to the selected individual menu when the input pad is tapped in a state where any one of the individual menus is selected.

3. The input device according to claim in wherein the processing unit outputs an execution signal for executing a program corresponding to the selected individual menu when a key input unit other than the input pad is pressed in the state where any one of the individual menus is selected.

4. The input device according to claim 1, wherein in the input pad, the number of the menu open regions corresponding to the number of the menu indications which have been indicated in the display image can be set to be arranged in the same direction as the arrangement direction of the menu indication, and when it is detected that any one of the menu open regions is operated by the operator, the menu content of the menu indication located in the location corresponding to the operated menu open region is displayed.

5. The input device according to claim 4, wherein the menu content corresponding to another menu indication is displayed when the operating location of the operator is moved in the arrangement direction of the menu open region in the state where the menu content corresponding to any one of the menu indications is displayed.

6. The input device according to claim 4, wherein the selection signal for selecting an individual menu among the displayed menus is outputted when it is detected that the input surface is operated by the operator in the direction intersecting the arrangement direction of the menu open region in the state where the menu content corresponding to any one of the menu indications is displayed.

7. The input device according to claim 1, wherein the processing unit is changed to in a menu select mode when it is detected that the menu open region is operated, and a pointer displayed on the screen is not moved even if the input surface is operated by the operator in the state where the processing unit is set to the menu select mode.

8. The input device according to claim 7, wherein the menu select mode is cancelled by pressing the key input unit other than the input pad.

9. A computer system comprising:
an input device including
an input pad configured to detect operations of an operator by detecting a variation in capacitance;
a detection unit configured to detect an operating location of the operator on the input pad;
a processing unit adapted to process a detection signal transmitted by the detection unit,
wherein, the processing unit recognizes a part of a region on an input surface of the input pad as a menu open region, outputs a menu operation signal for displaying menu contents corresponding to menu indications in a display image displayed on a screen on the basis of an application program when it is detected that the menu open region is operated by the operator, and outputs a selection signal for selecting an individual menu among the menus when a movement of the operator on the input surface is detected
an operating system receiving signals from the processing unit; and
a display unit displaying the display image under the control of the operating system.

10. The computer system claim 9, wherein the processing unit outputs an execution signal for executing a program corresponding to the selected individual menu when the input pad is tapped in a state where any one of the individual menus is selected.

11. The computer system claim 9, wherein the processing unit outputs an execution signal for executing a program corresponding to the selected individual menu when a key input unit other than the input pad is pressed in the state where any one of the individual menus is selected.

12. The computer system claim 9, wherein in the input pad, the number of the menu open regions corresponding to the number of the menu indications which have been indicated in the display image can be set to be arranged in the same direction as the arrangement direction of the menu indication, and when it is detected that any one of the menu open regions is operated by the operator, the menu content of the menu indication located in the location corresponding to the operated menu open region is displayed.
